(19) United States
(12) Patent Application Publication
(10) Pub. No.: US 2025/0074674 A1
(43) Pub. Date: Mar. 6, 2025

(54) FUNNEL STORAGE DEVICE

(71) Applicant: LIH YANN INDUSTRIAL CO., LTD., Taichung City (TW)

(72) Inventor: Po-Lin LIAO, Taichung City (TW)

(21) Appl. No.: 18/804,185

(22) Filed: Aug. 14, 2024

(30) Foreign Application Priority Data
Aug. 30, 2023 (TW) 112209266

(51) Int. Cl. B65D 61/02; B65D 25/24; B67C 11/02

(52) U.S. Cl. CPC B65D 61/02; B65D 25/24; B67C 11/02

(57) ABSTRACT

A funnel storage device is provided, wherein the funnel storage device includes: a tubular member including a first end portion and a second end portion; a receiving member connected to the first end portion, in communication with an interior of the tubular member, and tapering in a direction toward the first end portion; and a base connected to the second end portion, not in communication with the interior of the tubular member, and expanding in a direction away from the second end portion.

### BACKGROUND OF THE INVENTION

### Field of the Invention

The present invention relates to a funnel, particularly to a funnel storage device.

### Description of the Prior Art

The expanded mouth of a funnel can widely receive the liquid from a container, and the elongated pipe of the funnel can extend into the interior of another container, thereby smoothly guiding the liquid from a container into another one during use. This process significantly reduces the occurrence of liquid spillage and container overflow, effectively preventing waste and maintaining the working environment.

Funnels are extremely convenient for transferring fluids. However, after use, fluids often stick to the inside of the funnel. When the funnel is placed randomly or hung on a wall, the fluid inside the funnel can gradually drip out due to gravity, causing environmental mess and causing a slipping hazard to people.

The present invention is, therefore, arisen to obviate or at least mitigate the above-mentioned disadvantages.

### SUMMARY OF THE INVENTION

The main object of the present invention is to provide a funnel storage device which is configured to store a funnel and catch liquid left in the funnel, thus maintaining the surrounding environment's hygiene, cleanliness, and being conducive to working safety.

To achieve the above and other objects, a funnel storage device is provided, wherein the funnel storage device includes: a tubular member including a first end portion and a second end portion; a receiving member connected to the first end portion, in communication with an interior of the tubular member, and tapering in a direction toward the first end portion; and a base connected to the second end portion, not in communication with the interior of the tubular member, and expanding in a direction away from the second end portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is another perspective view of an exemplary embodiment of the present invention;

FIG. 3 is an exploded view of an exemplary embodiment of the present invention;

FIG. 4 is a cross-sectional view of an exemplary embodiment of the present invention;

FIG. 5 is a drawing showing an application of an exemplary embodiment of the present invention;

FIG. 6 is an exploded view of FIG. 5;

FIG. 7 is a perspective view of another exemplary embodiment of the present invention; and

FIG. 8 is a cross-sectional view of FIG. 7.

### DETAILED DESCRIPTION OF THE PREFERRED EMBODIMENTS

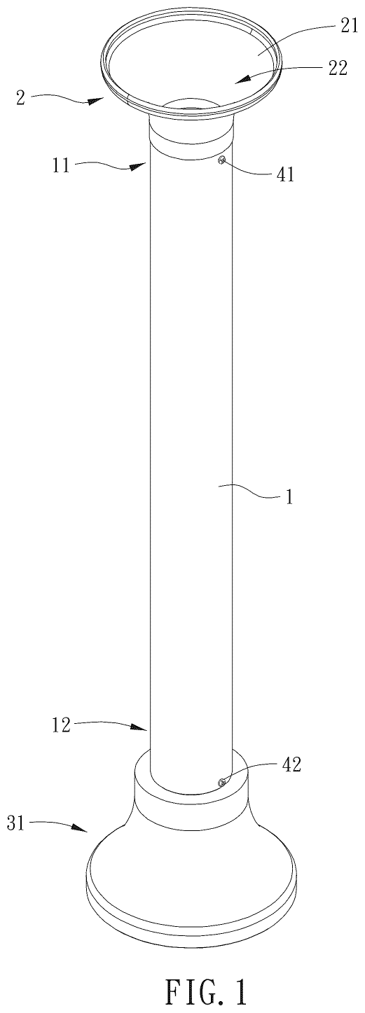

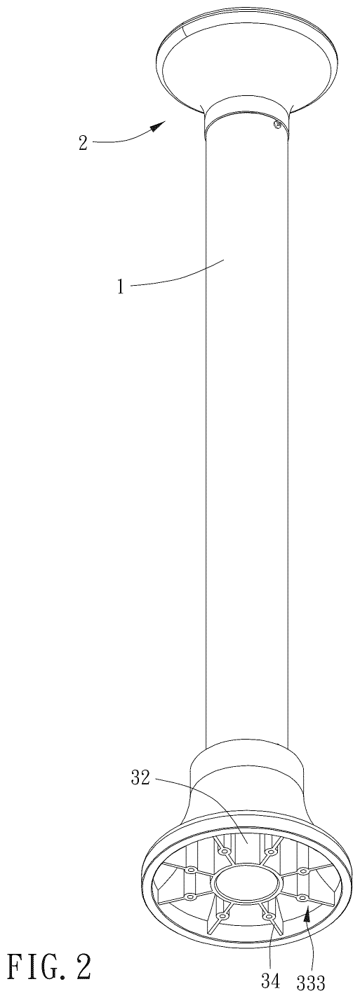

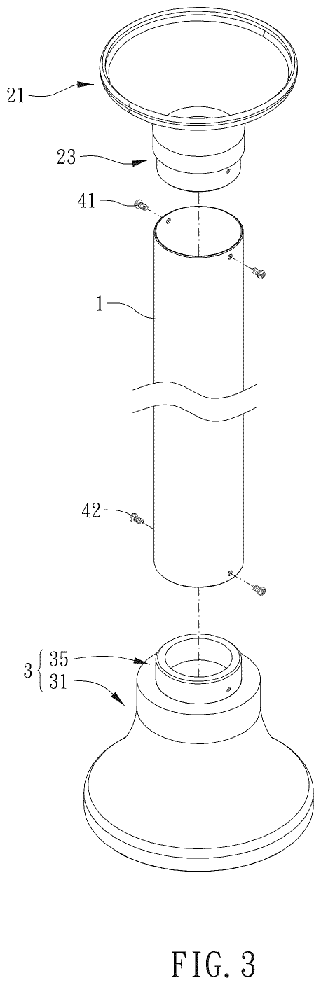

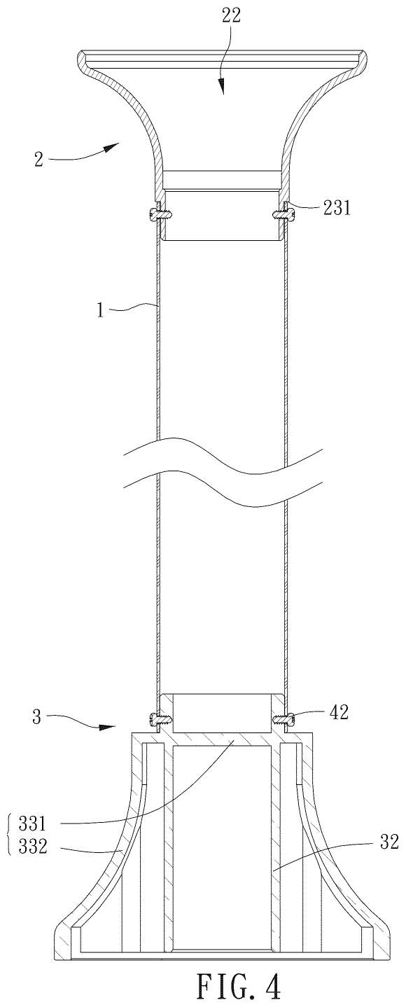

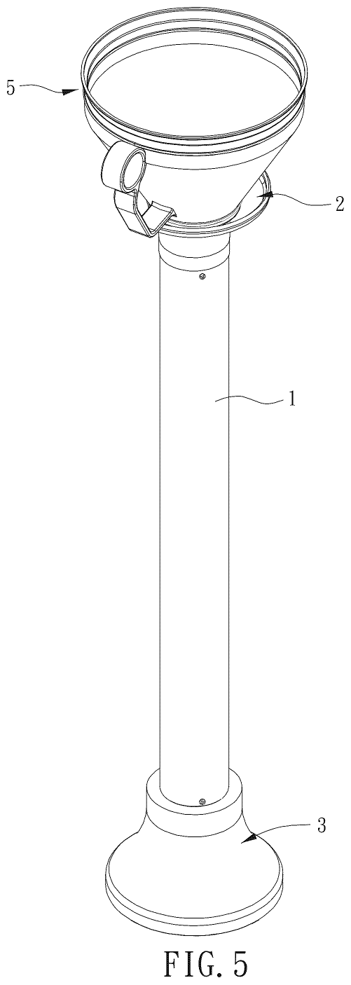

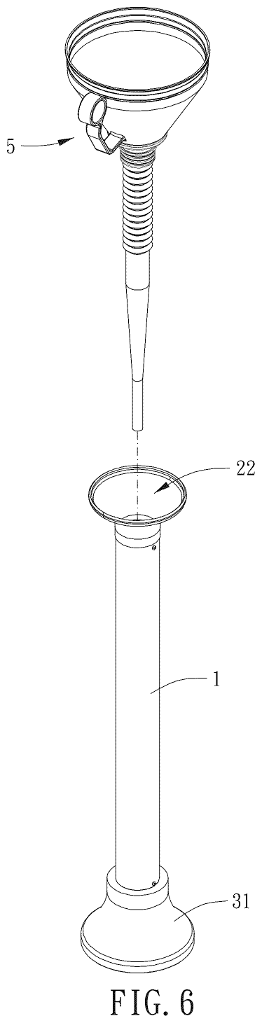

Please refer to FIGS. 1 to 6 for an exemplary embodiment of the present invention. A funnel storage device of the present invention includes a tubular member 1, a receiving member 2 and a base 3.

The tubular member 1 includes a first end portion 11 and a second end portion 12. The receiving member 2 is connected to the first end portion 11 and in communication with an interior of the tubular member 1. A funnel 5 may be inserted through the receiving member 2 into the interior of the tubular member 1 for storage. The receiving member 2 tapers in a direction toward the first end portion 11, so when liquid drips into the receiving member 2 during the insertion process of the funnel 5, the tapered structure helps guide the liquid into the interior of the tubular member 1. The base 3 is connected to the second end portion 12 and not in communication with the interior of the tubular member 1, which effectively stores the liquid dripping from the funnel 5 within the tubular member 1, maintains the surrounding environment's cleanliness and prevents slipping. The diametric dimension of the base 3 expands in a direction away from the second end portion 12, which increases the contact area with the placement surface and ensures stable standing of the funnel storage device.

In this exemplary embodiment, the base 3 has a maximum outer diametric dimension larger than a maximum outer diametric dimension of the receiving member 2 for better stability. The tubular member 1 a length of at least 400 mm, ensuring that the funnel storage device has sufficient height, approximately at knee height, for easy access and placement of the funnel 5. Additionally, the receiving member 2 and the base 3 are in different colors to help users quickly identify the orientation.

The receiving member 2 includes a receiving portion 21 and an insertion portion 23. The receiving portion 21 has an opening 22 tapering toward the insertion portion 23. The insertion portion 23 and the first end portion 11 are interconnected with each other, and the opening 22 is in communication with the interior of the tubular member 1. Specifically, an outer diametric dimension of the insertion portion 23 is smaller than an outer diametric dimension of the receiving portion 21, so that a shoulder 231 is disposed at a junction between the insertion portion 23 and the receiving portion 21. The shoulder 231 is axially abutted against the first end portion 11 of the tubular member 1, which ensures axial and radial contact between the tubular member 1 and the receiving member 2, and enhances the stability of the connection.

Preferably, the funnel storage device further includes at least one first fastener 41. The at least one first fastener 41 is inserted in and connects the insertion portion 23 and the first end portion 11, preventing the receiving member 2 from detaching from the tubular member 1. In this exemplary embodiment, the at least one first fastener includes two first fasteners 41 which are diametrically arranged and inserted in the tubular member 1.

The base 3 includes a seat 31 and a connection portion 35. An outer diametric dimension of the seat 31 expands in the direction away from the second end portion 12. The connection portion 35 is positioned within the seat 31, and configured to prevent communication between the interior of the tubular member 1 and the seat 31 to achieving a leak-proof effect. The tubular member 1 and the connection portion 35 are sleeved with each other. In this exemplary embodiment, the connection portion 35 and the seat 31 are integrally formed of one piece to reduce the number of components and assembly processes and to provide a more continuous structure capable of bearing the weight of the tubular member 1, the funnel 5 and the receiving member 2.

Specifically, the seat 31 includes a column 32, a cover 33 and a plurality of ribs 34. The cover 33 includes a top portion 331 and a circumferential portion 332. The connection portion 35 and the column 32 are disposed on opposing sides of the top portion 331. The plurality of ribs 34 are connected to and between the column 32 and the circumferential portion 332 to form a plurality of chambers 333. This structure provides lightweight and sufficiently structural strength. As the seat 31 is made of deformable materials such as rubber, pressing the seat 31 can expel the air in the chambers 333 to generate negative pressure suction, so it can further enhance positioning stability.

Specifically, the top portion 331 is flat and abutted against the second end portion 12. The top portion 331 has a minimum diametric dimension larger than a maximum diametric dimension of the tubular member 1, providing ample surface area for the tubular member 1 to abut against, ensuring sufficient support. The connection portion 35 is an annular protrusion extending on the top portion 331, has an outer diametric dimension larger than an outer diametric dimension of the column 32, and has a wall thickness greater than a wall thickness of the column 32, which enhances the structural strength at the junction between the base 3 and the tubular member 1.

Preferably, the funnel storage device further includes at least one second fastener 42. The at least one second fastener 42 is inserted in and connects the tubular member 1 and the connection portion 35, preventing the tubular member 1 from detaching from the connection portion 35. In this exemplary embodiment, the at least one second fastener includes two second fasteners 42 diametrically arranged and inserted in the tubular member 1.

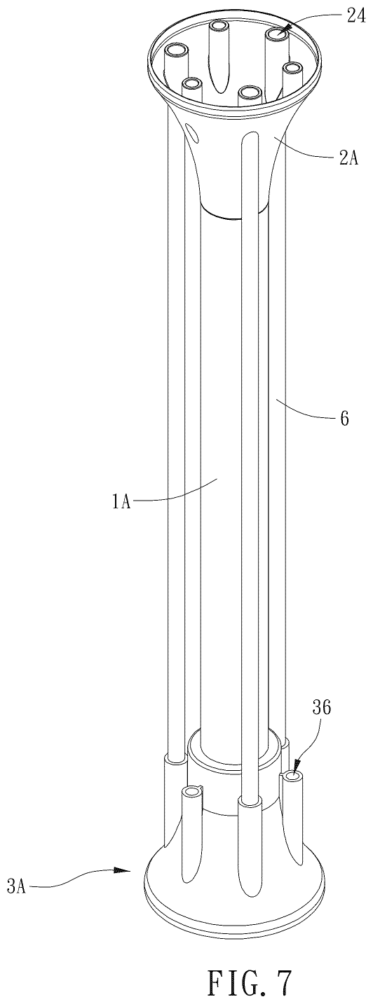

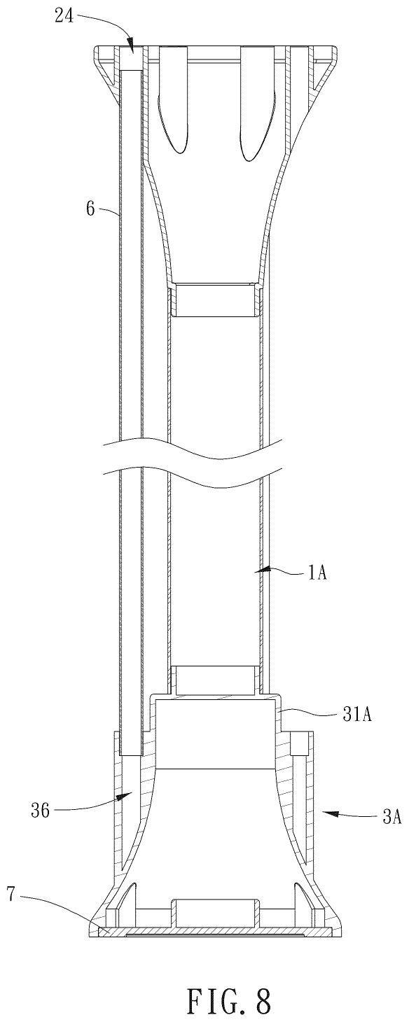

Please refer to FIGS. 7 and 8 for another exemplary embodiment. The funnel storage device further includes at least one pipe 6, the receiving member 2A includes at least one first insertion hole 24, and the base 3A includes at least one second insertion hole 36. The at least one pipe 6 are respectively inserted in the at least one first insertion hole 24 and the at least one second insertion hole 36. The diametric dimension of the at least one pipe 6 is smaller than the diametric dimension of the tubular member 1A, and a smaller suction pipe may be inserted in the at least one first insertion hole 24. The at least one pipe 6 and the at least one second insertion hole 36 can receive and store fluid falling from the suction pipe.

In another embodiment, the number of the at least one first insertion hole 24, the number of the at least one second insertion hole 36 and the number of the at least one pipe 6 are the same and plural. The plurality of the first insertion holes 24, the plurality of the second insertion holes 36, and the plurality of the pipes 6 are arranged at equal angular intervals around the tubular member 1A.

Additionally, in another embodiment, the funnel storage device further includes a lid 7. The lid 7 is covered on the seat 31A, and the lid 7 can increase the contact area between the seat 31A and the placement surface, thereby enhancing placement stability.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A funnel storage device including:
a tubular member including a first end portion and a second end portion;
a receiving member connected to the first end portion, in communication with an interior of the tubular member, and tapering in a direction toward the first end portion; and
a base connected to the second end portion, not in communication with the interior of the tubular member, and expanding in a direction away from the second end portion.

2. The funnel storage device of claim 1, wherein the receiving member includes a receiving portion and an insertion portion, the receiving portion includes an opening tapering toward the insertion portion, the insertion portion and the first end portion are interconnected with each other, and the opening is in communication with the interior of the tubular member.

3. The funnel storage device of claim 2, wherein an outer diametric dimension of the insertion portion is smaller than an outer diametric dimension of the receiving portion, a shoulder is disposed at a junction between the insertion portion and the receiving portion, and the shoulder is axially abutted against the first end portion of the tubular member.

4. The funnel storage device of claim 2, further including at least one first fastener, wherein the at least one first fastener is inserted in and connects the insertion portion and the first end portion.

5. The funnel storage device of claim 1, wherein the base includes a seat and a connection portion, an outer diametric dimension of the seat expands in the direction away from the second end portion, the connection portion is positioned within the seat and configured to prevent communication between the interior of the tubular member and the seat, and the tubular member and the connection portion are sleeved with each other.

6. The funnel storage device of claim 5, wherein the connection portion and the seat are integrally formed of one piece.

7. The funnel storage device of claim 5, wherein the seat includes a column, a cover and a plurality of ribs, the cover includes a top portion and a circumferential portion, the connection portion and the column are disposed on opposing sides of the top portion, and the plurality of ribs are connected to and between the column and the circumferential portion to form a plurality of chambers.

8. The funnel storage device of claim 5, further including at least one second fastener, wherein the at least one second fastener is inserted in and connects the tubular member and the connection portion.

9. The funnel storage device of claim 1, further including at least one pipe, wherein the receiving member includes at least one first insertion hole, the base includes at least one second insertion hole, the at least one pipe is inserted in the at least one first insertion hole and the at least one second insertion hole, and an outer diametric dimension of the at least one pipe is smaller than an outer diametric dimension of the tubular member.

10. The funnel storage device of claim 3, wherein the funnel storage device further includes at least one first fastener, the at least one first fastener is inserted in and connects the insertion portion and the first end portion; the base includes a seat and a connection portion, an outer diametric dimension of the seat expands in the direction away from the second end portion, the connection portion is positioned within the seat and configured to prevent communication between the interior of the tubular member and the seat, and the tubular member and the connection portion are sleeved with each other; the connection portion and the seat are integrally formed of one piece; the seat includes a column, a cover and a plurality of ribs, the cover includes a top portion and a circumferential portion, the connection portion and the column are disposed on opposing sides of the top portion, and the plurality of ribs are connected to and between the column and the circumferential portion to form a plurality of chambers; the funnel storage device further includes at least one second fastener, and the at least one second fastener is inserted in and connects the tubular member and the connection portion; the base has a maximum outer diametric dimension larger than a maximum outer diametric dimension of the receiving member; the at least one first fastener includes two first fasteners, the at least one second fastener includes two second fasteners, the two first fasteners are diametrically arranged and inserted in the tubular member, and the two second fasteners are diametrically arranged and inserted in the tubular member; the top portion is flat and abutted against the second end portion, and the top portion has a minimum diametric dimension larger than a maximum diametric dimension of the tubular member; the connection portion includes an annular protrusion on the top portion, the connection portion has an outer diametric dimension larger than an outer diametric dimension of the column, and the connection portion has a wall thickness larger than a wall thickness of the column; the tubular member has a length of at least 400 mm; the receiving member and the base are in different colors.
